(19) United States
(12) Patent Application Publication
(10) Pub. No.: US 2019/0023537 A1
(43) Pub. Date: Jan. 24, 2019

(54) ARRANGEMENT IN THE DOOR STRUCTURE OF AN ELEVATOR

(71) Applicant: KONE Corporation, Helsinki (FI)

(72) Inventors: Matti RÄSÄNEN, Helsinki (FI); Markku HAAPANIEMI, Helsinki (FI); Ilpo SUOMINEN, Helsinki (FI); Juho SIHVO, Helsinki (FI)

(73) Assignee: KONE Corporation, Helsinki (FI)

(21) Appl. No.: 16/143,195

(22) Filed: Sep. 26, 2018

Related U.S. Application Data
(63) Continuation of application No. PCT/FI2016/050257, filed on Apr. 19, 2016.

(51) Int. Cl. B66B 13/08; B66B 13/30; E05D 15/06

(52) U.S. Cl. CPC B66B 13/08; B66B 13/30; E05Y 2800/416; E05Y 2900/104; E05D 15/0652

(57) ABSTRACT

An arrangement in the door structure of an elevator includes at least an elevator car with doors and door panels, landing doors of the landing areas with door panels and a hanger carriage of each door panel, as well as a top track for the doors, supported on which top track the doors are suspended. The top track includes a separate frame beam, which is enclosed for essentially its whole length with a reinforcement structure.

The object of the present invention is an arrangement, as defined in the preamble of claim 1, in the door structure of an elevator.

In solutions known in the art an elevator car door and elevator landing door typically have a hanger beam, i.e. a top track, to which is fixed the door operator as well as a roller guide for the hanger rollers of the door panels, suspended on which hanger rollers the door panels are moved in the horizontal direction when opening and closing the door. The top track and roller guide are typically made from a steel structure for fire safety reasons, because in a fire scenario the doors must remain in their position. A problem with a top track and roller guide fabricated from steel is, however, the weight of the steel, which makes the car structure of the elevator heavier and makes installation difficult. Fixing points, such as holes, are made parametrically in the top track for fastening the top track to the elevator car structure and/or to the elevator landing. Parametric locations of fixing points means that the fixing points must be in precisely a certain location, depending on the elevator type and/or door type, for the top track to be installed correctly onto the fastening means of the elevator car and/or of the landing. In this case one problem is that the top tracks must be fabricated to be type-specific for different door models. If there are any imprecisions in the fixing points a completely new part must be ordered to the installation site, which delays the time-critical installation process. One problem is also the costs of fabricating the top track and roller guide, since they are made from steel into a difficult shape and with parametric fixing points.

The aim of this invention is to eliminate the aforementioned drawbacks and to achieve an easily and quickly installable and lightweight door arrangement of an elevator, the arrangement having low manufacturing and installation costs and a fire-resistant construction. Another aim is to achieve a combined hanger beam and roller guide, hereinafter frame beam, of a door arrangement, the frame beam being non-parametric and being suited “as is” as a component of preferably many different types of car and landing doors for an elevator. Non-parametrical in this context means that no fixing holes of any kind need to be e.g. dimensioned and made in the frame beam. The only dimensioning needed for the frame beam is the measuring of the frame beam and cutting it to the correct length. The arrangement according to the invention is characterized by what is disclosed in the characterization part of claim 1. Other embodiments of the invention are characterized by what is disclosed in the other claims.

Some inventive embodiments are also discussed in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can in at least some situations be deemed to be inventive in their own right.

Characteristic of one preferred embodiment of the invention is that the top track comprises a separate frame beam, which is enclosed with a reinforcement structure for essentially its whole length, the endurance against fire and heat of which reinforcement structure is better than the endurance of the frame beam against fire and heat.

One of the advantages, among others, that can be achieved by means of the invention is that by means of it a car- and landing-door arrangement is enabled that saves space and is advantageous in terms of its cost level. Another advantage is the lightweight structure, owing to which the doors are easy and quick to install into position and, owing to this ease, possible installation errors also decrease. A lightweight structure is enabled by using a thin, panel-type door panel and replacing the separate, heavy, steel top track with a lighter structure and lighter materials.

One significant advantage is the possibility of making the load-bearing frame beam of the top track from a material that is lighter than steel, such as from aluminium or plastic, with inexpensive manufacturing methods, preferably even using an aluminium profile rod or extruded plastic rod, available cheaply and sold by the meter, as the load-bearing frame beam. In a fire scenario these materials might at a high temperature lose their load-bearing carrying capability, but the enclosing of the frame beam with a thin reinforcement element, such as with a steel plate, ensures that the doors will stay in place and ensures the fire resistance of the structure.

Another advantage is the non-parametric nature of the arrangement, when the frame beam is a profile having fixing grooves on the top and bottom for the length of the structure. In this case all the parts can be fastened from their fixing grooves easily and at any point whatsoever to the fixing means of the elevator car and/or of the landing floor of the building. The same advantageous non-parametrical parts are compatible with many different elevator door types, in which case these parts do not need to be fabricated separately for specific door types.

An advantage of a lightweight structure generally is that it also enables lighter counterweights/compensating weights, lower energy consumption when the elevator car moves and in fast elevators, among others, easier balancing of the car.

Likewise fewer raw materials are needed. One advantage is also the small number of parts needed in the door structure, which in turn makes installation easier and lowers the cost level.

In a preferred embodiment of the invention, in the elevator door structure, whether it is the door structure of a door of an elevator car or of a door of a landing area, is a door panel of a door suspended by means of a hanger carriage or otherwise, e.g. directly by means of wheels on the door panel, on a top track suspending the door panel in question, the top track comprising a separate frame beam, which is enclosed for essentially its whole length with a reinforcement structure. The endurance of the reinforcement structure against fire and heat is better than the endurance of the frame beam itself against fire and heat.

In the following, the invention will be described in detail by the aid of one example of its embodiment with reference to the simplified and diagrammatic drawings attached, wherein

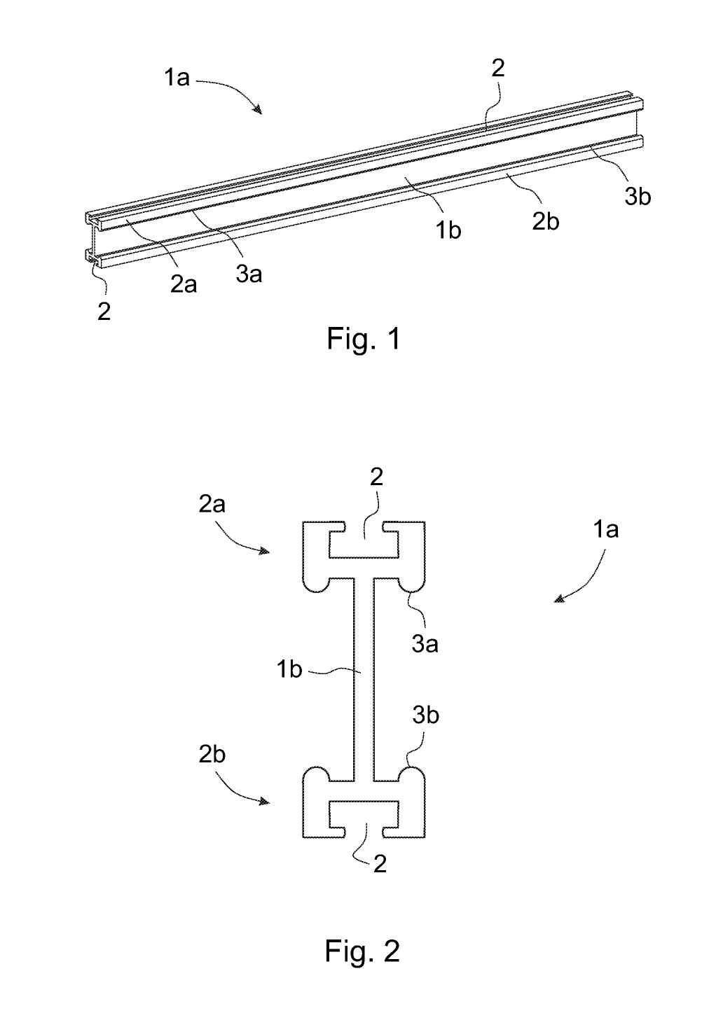

FIG. 1 presents an oblique top view of one frame beam, according to the invention, of a top track of a car door or landing door of an elevator,

FIG. 2 presents an end view of a frame beam, according to FIG. 1, of a top track of a car door or landing door of an elevator,

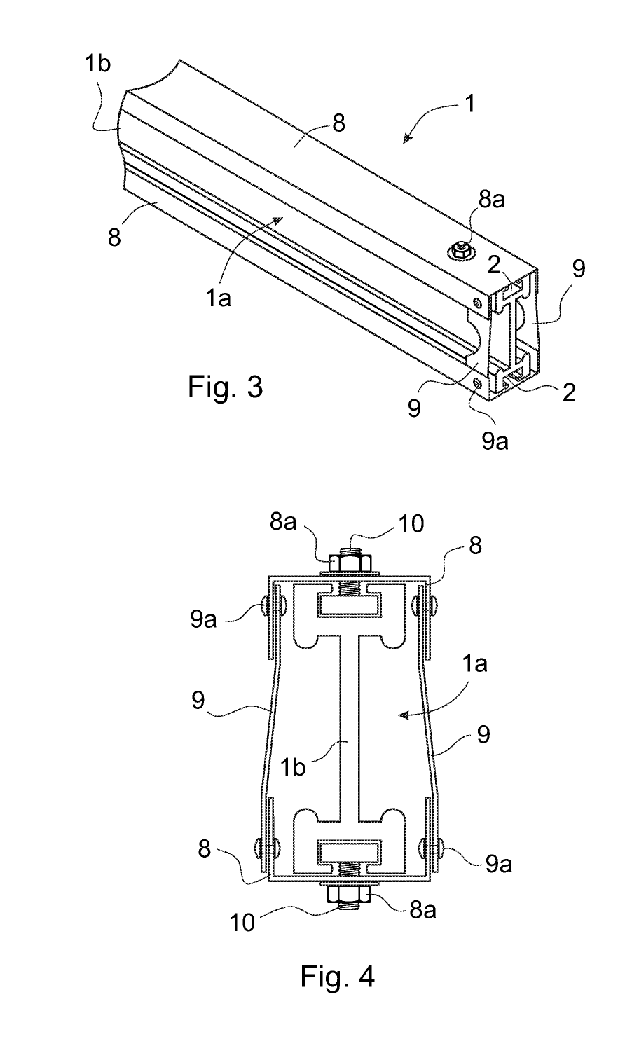

FIG. 3 presents an oblique top view of one of a top track, according to the invention, of a car door or landing door of an elevator, in which top track the frame beam is one part,

FIG. 4 presents an end view of a top track, according to FIG. 3, of a car door or landing door of an elevator, in which top track the frame beam is one part,

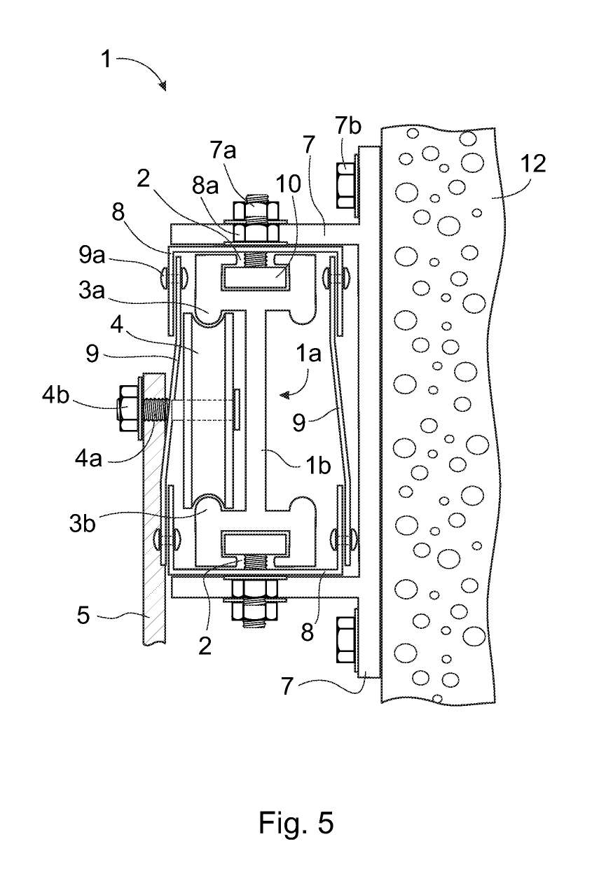

FIG. 5 presents a simplified end view of one top track according to the invention installed into position on the wall of the elevator hoistway, and

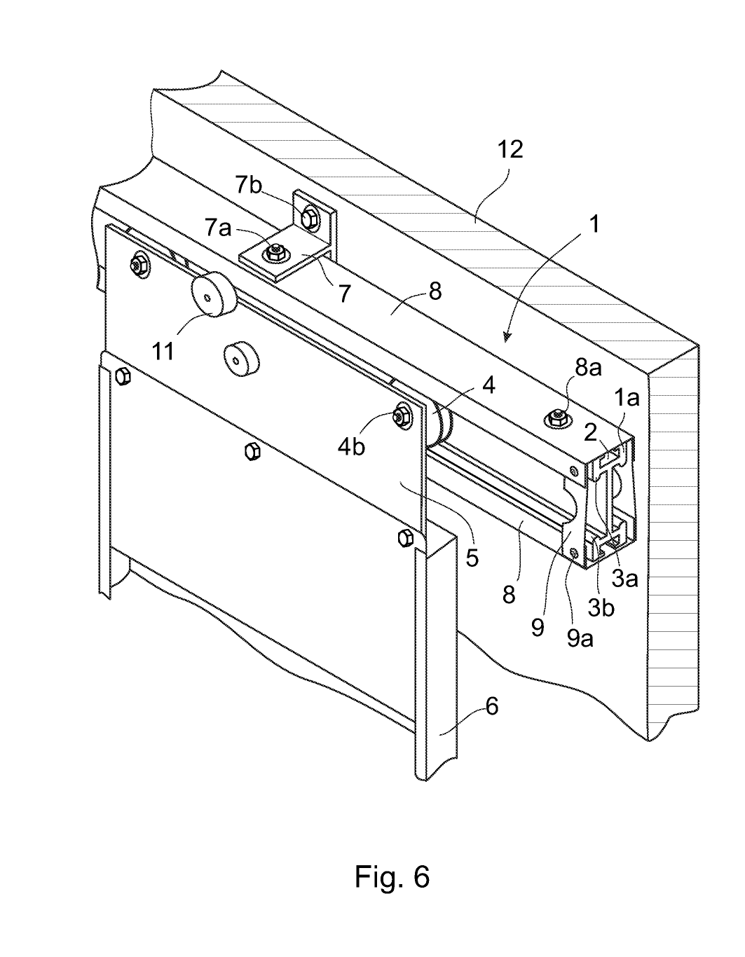

FIG. 6 presents a simplified and sectioned oblique top view of one top track according to the invention, provided with hanger rollers and with a door panel.

FIGS. 1 and 2 present one frame beam 1a according to the invention supporting the top track of a car door or landing door of an elevator, as viewed obliquely from above and also when magnified and viewed directly from the end. The frame beam 1a is a straight, elongated profile beam, which resembles an I-profile in its cross-section and which is fabricated from an essentially light material, such as aluminium. In the middle of the frame beam 1a is an essentially thin web plate 1b, on the top edge of which is a top flange 2a that is wider than the thickness of the web plate 1b and, correspondingly, on the bottom edge of which is a bottom flange 2b that is wider than the thickness of the web plate 1b. In the horizontal direction the web plate 1b is symmetrically in the center of the flanges 2a, 2b, as viewed from the end, but in different embodiments the web plate 1b can also be in another location than symmetrically in the center of the flanges 2a, 2b.

In the horizontal direction in the center of the top flange 2a is a fixing groove 2 opening upwards from the center, the bottom part of which fixing groove is in the cross-sectional direction wider than the upwardly-opening top part. Correspondingly, in the horizontal direction in the center of the bottom flange 2b is a fixing groove 2 opening downwards from the center, the top part of which fixing groove is in the cross-sectional direction wider than the downwardly-opening bottom part. The fixing grooves 2 are essentially as long as the flanges 2a, 2b and the web plate 1b of the frame beam. In the fixing grooves 2 it is possible to move fastening means, such as fixing bolts, disposed in the grooves non-parametrically at suitable points.

Additionally, on the frame beam 1a on both sides of the web plate 1b are a top guide rail 3a, as well as a bottom guide rail 3b, provided with a rolling surface for the hanger rollers of the door panels. The guide rails 3a, 3a are essentially as long as the whole frame beam and are preferably composed of the same material as the frame beam 1a, and are thus integrated into the frame beam 1a. The rolling surface on the top guide rails 3a is essentially downwards and the rolling surface on the bottom guide rails 3b is essentially upwards.

FIGS. 3-6 present simplified views of one top track 1, according to the invention, of a car door or landing door of an elevator. In FIG. 3 the top track 1 is presented when detached and viewed obliquely and cross-sectioned, and in FIG. 4 when detached and viewed directly from the end. Correspondingly, in FIG. 5 the top track 1 is presented as viewed directly from the end and when fixed into its position on the wall 12 of the elevator hoistway, and also in FIG. 6 as viewed obliquely from above and when fixed into its position on the wall 12 of the elevator hoistway.

The frame beam 1a of the top track 1 is fixed to the suspension members 7 from its fixing groove 2 with fastening means 10 and 7a, such as with a bolt/nut combination. Since the fixing grooves 2 are of profile type in cross-section and are the length of the whole frame beam 1a, fixing of the frame beam 1a and at the same time of the top track 1 non-parametrically and flexibly to the suspension members 7 will succeed regardless of how the suspension members 7 are positioned on the top part of the door opening. The suspension members 7 are rigidly fixed to the frame of the elevator car and/or to the elevator hoistway wall 12 for the landing with fastening means 7b, such as with fixing bolts, above the door opening of the elevator.

Between the top guide rail 3a and the bottom guide rail 3b of the frame beam 1a is a hanger roller 4 having a groove for the guide rails 3a, 3b, which groove enables the hanger roller 4 to move linearly on the horizontal plane along the guide rails 3a, 3b and enables the hanger roller 4 to stay between the guide rails 3a, 3b. The hanger carriage 5 for the door panel 6 5 is suspended on the frame beam 1a, by means of hanger rollers 4, fixing bolts 4a functioning as axles, and fixing nuts 4b. A door panel 6 as well as some of the other operating mechanisms, which for the sake of clarity are not presented here, are fastened to the hanger carriage 5.

The frame beam 1a is protected for essentially its whole length from both above and below as well as from the top part and bottom part of its sides with fire-resistant and heat-resistant reinforcement elements 8, such as with steel profiles having a cross-sectional shape that is e.g. essentially U-shaped. The reinforcement elements 8 can be e.g. profiles bent from steel plate. The reinforcement elements 8 are fixed into the fixing grooves 2 of the frame beam 1a with fastening means 10 and 8a, such as with a bolt/nut combination. At the point of the suspension members 7 the reinforcement elements 8 are attached to the frame beam 1a with the same fastening means 10 and 7a as the whole top track 1. The top and bottom reinforcement elements 8 are connected to each other at their ends with tie members 9, such as steel plates, that are resistant to fire and heat and that are fixed to the reinforcement elements 8 with fastening means 9a, such as steel rivets, that are resistant to fire and heat.

The above-described enclosure of the frame beam assembled from the reinforcement elements 8 and tie members 9 functions as a reinforcement structure of the top track 1, the reinforcement structure being arranged to strengthen the structure of the top track 1 and to ensure the doors stay in place in a fire scenario, in which the lighter structure of the frame beam 1a has possibly lost its load-bearing capability e.g. due to melting. The melting temperature, i.e. the melting point, of the material of the reinforcement elements 8 and tie members 9 is higher than the melting temperature of the frame beam 1a.

In this case the endurance of the reinforcement elements 8 and tie members 9 against fire and heat is better than the endurance of the frame beam 1a against fire and heat, so that the reinforcement elements 8 and tie members 9 are arranged to support the door panels 6 in case the frame beam 1a and/or the hanger rollers 4 of the door panels 6 melt from the heat. In this case at least the fixing bolts 4a functioning as axles for the hanger rollers 4 are arranged to rest on the support of the lower reinforcement element 8.

The different solutions and features presented above can be inventive features together with one or more other features of the invention.

It is obvious to the person skilled in the art that the invention is not limited solely to the examples described above, but that it may be varied within the scope of the claims presented below. Thus, for example, the frame beam can also be different in shape than what is described. It can have e.g. a roller groove for the hanger roller instead of a top guide rail and bottom guide rail. In addition, the hanger rollers can be e.g. smaller than the hanger rollers presented, in which case some of the rollers can be support rollers which rest on the rolling surface of the top guide rails.

It is also obvious to the person skilled in the art that the suspension members of the top track of the door panels can also be different in their structure and shape to what is presented above.

It is additionally obvious to the person skilled in the art that the material of the frame beam can also be of some other material than aluminium that is softer, lighter and more malleable than steel. It can be e.g. of plastic or of plastic composite or of some other suitable material.

1. An arrangement in the door structure of an elevator, the elevator comprising:
at least an elevator car with door panels;
landing doors of the landing areas with door panels;
a hanger carriage of each door panel; and
at least one top track,
wherein at least one door panel is suspended on the at least one top track,
wherein the at least one top track comprises a separate frame beam, the separate frame beam being enclosed for essentially an entire length thereof with a reinforcement structure.

2. The arrangement in the door structure of an elevator, the elevator comprising:
at least an elevator car with door panels;
landing doors of the landing areas with door panels;
a hanger carriage of each door panel; and
at least one top track suspending at least one door panel,
wherein the top track comprises a separate frame beam, the separate frame beam being enclosed for essentially an entire length thereof with a reinforcement structure.

3. The arrangement according to claim 1, wherein the endurance of a reinforcement structure against fire and heat is better than the endurance of a frame beam against fire and heat.

4. The arrangement according to claim 1, wherein the melting temperature of a reinforcement structure is higher than the melting temperature of the frame beam.

5. The arrangement according to claim 1, wherein the reinforcement structure comprises reinforcement elements situated around the top part and bottom part of the frame beam and tie members connecting the ends of the reinforcement elements, and wherein when the supporting of the frame beam fails, the hanger carriages of the door panels are arranged to rest on the support of at least the lower reinforcement elements of the frame beam.

6. The arrangement according to claim 1, wherein the frame beam is an essentially elongated profile of a constant cross-section, comprising on a top surface and a bottom surface thereof fixing grooves in the longitudinal direction of the frame beam for the entire length of the frame beam.

7. The arrangement according to claim 6, wherein the reinforcement elements are arranged to be fixed to the frame beam by means of fasteners disposed non-parametrically in the fixing grooves.

8. The arrangement according to claim 6, wherein the top track is arranged to be fixed into position by means of fasteners disposed non-parametrically in the fixing grooves of the frame beam.

9. The arrangement according to claim 1, wherein the frame beam is fabricated into a one-piece profile from a lightweight and malleable material and is in its entirety of one and the same material.

10. The arrangement according to claim 8, wherein the frame beam is an aluminium profile or a plastic profile fabricated by extrusion.

11. The arrangement according to claim 2, wherein the endurance of a reinforcement structure against fire and heat is better than the endurance of a frame beam against fire and heat.

12. The arrangement according to claim 2, wherein the melting temperature of a reinforcement structure is higher than the melting temperature of the frame beam.

13. The arrangement according to claim 3, wherein the melting temperature of a reinforcement structure is higher than the melting temperature of the frame beam.

14. The arrangement according to claim 2, wherein the reinforcement structure comprises reinforcement elements situated around the top part and bottom part of the frame beam and tie members connecting the ends of the reinforcement elements, and wherein when the supporting of the frame beam fails, the hanger carriages of the door panels are arranged to rest on the support of at least the lower reinforcement elements of the frame beam.

15. The arrangement according to claim 3, wherein the reinforcement structure comprises reinforcement elements situated around the top part and bottom part of the frame beam and tie members connecting the ends of the reinforcement elements, and wherein when the supporting of the frame beam fails, the hanger carriages of the door panels are arranged to rest on the support of at least the lower reinforcement elements of the frame beam.

16. The arrangement according to claim 4, wherein the reinforcement structure comprises reinforcement elements situated around the top part and bottom part of the frame beam and tie members connecting the ends of the reinforcement elements, and wherein when the supporting of the frame beam fails, the hanger carriages of the door panels are arranged to rest on the support of at least the lower reinforcement elements of the frame beam.

17. The arrangement according to claim 2, wherein the frame beam is an essentially elongated profile of a constant cross-section, comprising on a top surface and a bottom surface thereof fixing grooves in the longitudinal direction of the frame beam for the whole length of the frame beam.

18. The arrangement according to claim 3, wherein the frame beam is an essentially elongated profile of a constant cross-section, comprising on a top surface and a bottom surface thereof fixing grooves in the longitudinal direction of the frame beam for the whole length of the frame beam.

19. The arrangement according to claim 4, wherein the frame beam is an essentially elongated profile of a constant cross-section, comprising on a top surface and a bottom surface thereof fixing grooves in the longitudinal direction of the frame beam for the whole length of the frame beam.

20. The arrangement according to claim 5, wherein the frame beam is an essentially elongated profile of a constant cross-section, comprising on a top surface and a bottom surface thereof fixing grooves in the longitudinal direction of the frame beam for the whole length of the frame beam.
